(19) United States
(12) Patent Application Publication
(10) Pub. No.: US 2006/0219808 A1
(43) Pub. Date: Oct. 5, 2006

(54) Cleaning actuator for aerosol cans

(75) Inventor: John R. Woods, Woodland Hills, CA (US)

Correspondence Address: Carolyn Lu, Suite 2800, 725 S. Figueroa Street, Los Angeles, CA, 90017, US

(73) Assignee: Sparytex, Inc., Valencia, CA (US)

(21) Appl. No.: 11/369,418

(22) Filed: Mar. 7, 2006

Related U.S. Application Data
(60) Provisional application No. 60/662,654, filed on Mar. 17, 2005.

(51) Int. Cl. B05B 15/02; B67D 1/08

(52) U.S. Cl. 239/123; 222/151; 239/114; 239/117; 239/337

(57) ABSTRACT

An actuator that can self-clean is disclosed for use with an aerosol spray container designed to spray materials without clogging like traditional aerosol spray containers. More particularly, the actuator includes an insert that can be pushed in or manipulated to break up clogs, consequently allowing the user to eject the clog.

### RELATED APPLICATIONS

This application claims the benefit of U.S. Provisional Application No. 60/662,654 titled “CLEANING ACTUATOR FOR AEROSOL FANS,” filed Mar. 17, 2005, which is herein incorporated by reference in its entirety.

### BACKGROUND OF THE INVENTION

1. Field of Invention

Embodiments of the present invention relate generally to an actuator for use with a pressurized aerosol spray can that delivers viscous materials or materials with large particulates, without clogging or packing as traditional actuators do when used with such aerosol spray cans. More particularly, embodiments of the present invention relate to a self-cleaning actuator that includes an insert that can be pushed in to break up any clog, consequently allowing the user to eject the clog.

2. Description of Related Art

Aerosol actuators are generally used to atomize a pressurized liquid into a spray which can be delivered to coat an object with the atomized spray. A traditional actuator can be used with an aerosol spray can to facilitate the spraying of a wide range of materials. However, the practice of dispensing materials through traditional aerosol spray can valve assemblies in the aerosol industry has presented problems. One common problem is that, in a traditional aerosol spray can valve assembly, after the material is sprayed residual material often sits and dries in the actuator and clogs the actuator or valve assemblies.

Another problem occurs when heavy and particulate materials are dispensed through traditional aerosol spray can valve assemblies. These heavy and particulate materials may include exterior stucco, heavy sand finishes, drywall and acoustic ceiling patching materials, fire suppressant materials, adhesive and bonding materials, and even culinary sauces. The commonly encountered problem lies in the fact that the heavy and particulate materials to be dispersed often clog the valve assemblies or the actuator itself, rendering the traditional aerosol spray containers inoperative. Even if the traditional valve assemblies or traditional actuator are not completely clogged, the continuous build up of the sprayed materials can lead to inconsistent application of the sprayed material.

Most traditional aerosol actuators comprise of a body with a discharge opening area. This discharge opening area includes an orifice in which an insert is placed so that the insert is flush with the body. Commonly, these bodies and inserts are composed of different hard materials. Such actuator assemblies suffer from clogging or packing of the actuator or valve assembly due to the particulates contained in the sprayed texture material, especially if those particulates are large like those found in stucco or other heavy particulate materials mentioned above.

Therefore, there exists a long-standing need to provide an actuator that may be used to readily dispense a wide range of materials, especially heavy and particulate materials, in aerosol form either without clogging or with a way to facilitate unclogging.

### BRIEF SUMMARY

In accordance with an embodiment of the invention, an actuator has been developed for use in association with aerosol spray cans known in the art. An embodiment of the present invention provides an actuator that can be used to spray a wide range of materials, including heavy and particulate materials, such as exterior stucco, heavy sand finishes, drywall and acoustic ceiling patching materials, fire suppressant materials, adhesive and bonding materials, and even culinary sauces, without clogging or packing of the valve assemblies or actuator. The actuator may be compatible for use with any generic aerosol spray can.

The actuator according to an embodiment of the invention is composed of a body that includes an insert composed of silicon, rubber, soft plastic, or other flexible material. Rather than be flushed with the body, like in traditional actuators, the insert of the invention extends out from the body approximately ⅛ inch. This length can also vary from about ⅛ inch to around ½ inch. In a further embodiment, the length may be less than ⅛ inch. In the case that the sprayed material clogs or packs the actuator, the user may then push the flexible insert in or side-to-side to break up the clog. By moving or pushing the insert, the pressure generated breaks the formed clog. This releases the broken particles and helps eject the broken clog from the valve assembly or actuator.

The insert may have various shape embodiments that facilitate the breaking of the clog. For example, the different embodiments may include inserts with cross-sections of various shapes. In each embodiment, the flexible insert may be pushed inwards and maneuvered in different directions to help further the breaking of the clog.

### BRIEF DESCRIPTION OF THE DRAWINGS

A detailed description of embodiments of the invention will be made with reference to the accompanying drawings, wherein like numerals designate corresponding parts in the figures.

FIG. 1 is a cross-sectional view of an actuator assembly in disassembled form according to an embodiment of the invention.

FIG. 2 is a cross-sectional view of a valve assembly according to an embodiment of the invention.

FIG. 3 is an external front-end view of an actuator assembly according to an embodiment of the invention.

FIG. 4 is a cross-sectional view of an actuator assembly showing the manner in which the insert is pushed in to break a clog according to an embodiment of the invention.

### DETAILED DESCRIPTION

In the following description, reference is made to the accompanying drawings which form a part hereof and which illustrate several embodiments of the present invention. It is understood that other embodiments may be utilized and structural and operational changes may be made without departure from the scope of the present invention.

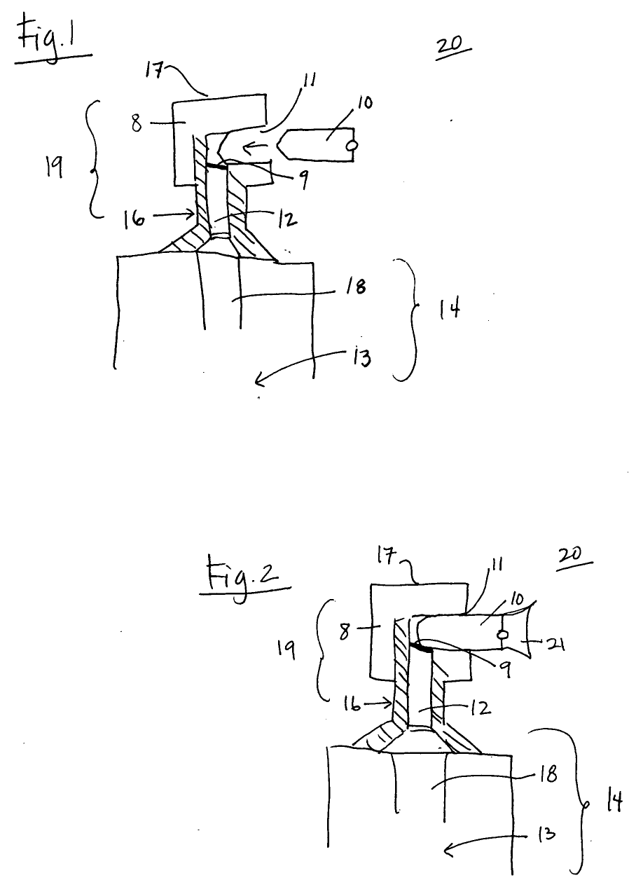

FIGS. 1-3 illustrate an actuator according to an embodiment of the invention, shown schematically by the reference numeral 19, for an aerosol spray can 14. The actuator 19 comprises a body 8 that includes an inlet 9, an insert 10 that fits into the orifice 11 of the inlet 9, and a main valve 12 that leads down into the cavity 13 of the can 14. The insert 10 fits in the orifice 11 in a way so that part of the insert 10 protrudes from the orifice 11 (rather than be flushed with the body 8) once the insert 10 is fully placed in the inlet 9. The present insert 10 extends out from the body 8 approximately ⅛ inch. This length can vary from about ⅛ inch to about ½ inch. The length may also be less than ⅛ inch in some embodiments. The body 8 is mounted on a neck 16 that contains the main valve 12 that leads down into the cavity 13 of the can 14. The top of the actuator 19 forms a button tip 17 on which the user may push down upon to engage the actuator 19 and deliver an aerosol spray. The lower part of the main valve 12 extends into a lower valve 18. Once the actuator assembly 20 is engaged, the main valve 12 and the lower valve 18 maintain fluid communication to dispense the contents from the cavity 13 up to the inlet 9 and exit through the insert 10, as with other aerosol spray cans known in the art. In an alternative embodiment, the container may include a propellant, such as compressed air or liquid gas, to further facilitate the force of expulsion and blast velocity released.

The button tip 17 provides an area for a user to apply pressure to the actuator 19 in order to open the main valve 12 to which the actuator 19 is connected. By opening the main valve 12 the pressurized contents of the cavity 13 are released up through the main valve 12 and into the inlet 9 where it is delivered out through the insert 10.

The common problem encountered in the traditional actuator assembly, after the material is sprayed, is that the residual material often sits and dries upon the actuator and clogs the insert or the inlet. Another problem occurs when heavy and particulate materials are dispensed through traditional aerosol spray cans. These heavy and particulate materials, such as exterior stucco, heavy sand finishes, drywall and acoustic ceiling patching materials, fire suppressant materials, adhesive and bonding materials, and even culinary sauces, often clog the main valve as well as the inlet and insert, rendering the traditional aerosol spray containers inoperative.

In an embodiment of the present invention, when residual material has dried and clogged the inlet 9 or insert 10, the user may break the clog by pushing in on the insert 10 an/or moving the insert 10 with a side-to-side motion. In an embodiment, the insert 10 is composed of silicon, a flexible material that allows a user to bend or manipulate the insert. Other embodiments may include inserts composed of rubber, soft plastic, or other flexible materials. The protruding part of the insert 10 is pushed inwards, and the user may manipulate the flexibility of the insert 10 to break up the clog. Likewise, if a clog is formed in the main valve 12, the insert 10 may be maneuvered to flex the main valve 12 and generate movement and pressure through the main valve 12 so as to break up and expel the clog from its location.

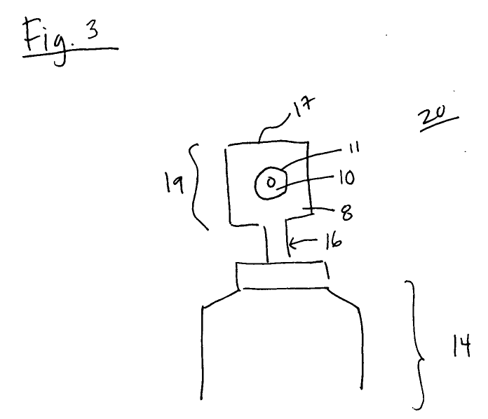

In FIG. 1, an actuator assembly 20 is shown in a disassembled form according to an embodiment of the invention. The insert 10 is shown extending beyond the orifice 11 of the inlet 9. FIG. 2 illustrates an actuator 19 fully assembled with the extended insert 10 fit within the orifice 11. The insert 10 is seen protruding out from the actuator body 8, unlike in a traditional actuator. The insert 10 is fit within the orifice 11 of the inlet 9, which is connected to the main valve 12 and lower valve 18. By pushing in the insert 10, clogs can be broken and removed by the movement generated through the insert 10. Additionally, the user may manipulate the insert 10 to further facilitate the break up and removal of a clog that is lodged in the actuator 19 or the actuator assembly 20. In embodiments, the insert may be equipped with a flange 21 on one end to provide the dispensed spray with either a wider or narrower projection.

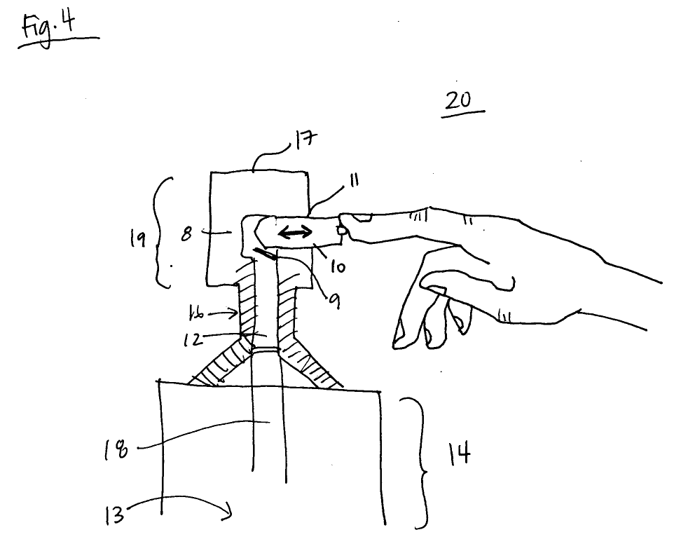

In FIG. 3, an external front-end view of an actuator 19 according to an embodiment of the invention is shown. The insert 10 can be seen placed inside the orifice 11 of the inlet 9. The body 8 is mounted on the neck 16 wherein the main valve (not shown) is contained. Applying pressure to the button tip 17 will open the main and lower valve (not shown) and release the contents through the insert 10 in an aerosol spray.

FIG. 4 illustrates the movement of the insert 10 in which formed clogs can be broken and removed from the various locations in the actuator assembly 20. The user may push the insert 10 inwards or grasp the insert 10 and maneuver the insert 10. The movement impacts the other parts of the actuator assembly 20, such as the inlet 9, main valve 12 and lower valve 18, to break up clogs and remove the clogs. The access to the insert 10 may be by way of the user's fingers or nails. Alternatively, the access to the insert 10 may be by way of pliers, a screwdriver, or other device that is capable exerting a force on the nozzle so that it may be extended further from the actuator, and then reinserted. Such reinsertion may be to the original position of the insert 10 or further out than the original position or further within than the original position. Depending on the size or material type of the clog, more or less pressure may be required to break up the clog. In some instances, one forward and back motion may be sufficient to dislodge the clog or packed material. In other instances it may be necessary to repeat the process two or more times.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are, therefore, to be considered in all respects as illustrative and not restrictive, the scope of the invention being indicated by the appended claims rather than the foregoing description. All changes that come within the meaning of and range of equivalency of the claims are intended to be embraced therein.

What is claimed is:

1. An actuator assembly for an aerosol container comprising:
an actuator body;
an orifice formed in the actuator body, wherein the orifice defines an inlet;
a main valve and a lower valve operatively located between the sprayable material and the inlet, the valves being in fluid communication with one another and adapted to open and close communication between the sprayable material and the inlet; and
an insert configured to sit within and extend from the inlet, wherein the insert is adapted to move in various directions within the inlet to clear any clogs forming in the actuator assembly.

2. The actuator assembly according to claim 1 further including a button tip disposed on the actuator body.

3. The actuator assembly according to claim 1, wherein a user clears the clogs by moving the insert in a forwards and backwards or side-to-side motion.

4. The actuator assembly according to claim 1, wherein the insert extends out from the actuator body by a length of up to about ½ inch.

5. The actuator assembly according to claim 1, wherein the insert extends out from the actuator body by a length of from about ⅛ inch to about ½ inch.

6. The actuator assembly according to claim 1, wherein the insert is formed from a material selected from the group consisting of silicone, rubber, soft plastic and mixtures thereof.

7. The actuator assembly according to claim 1, wherein the insert further includes a flange on one end to direct the sprayable material.

8. An aerosol system comprising a container, a sprayable material and an actuator assembly that sprays the sprayable material from the container, wherein the actuator assembly comprises:
an actuator body;
a button tip disposed on the actuator body;
an orifice formed in the actuator body, wherein the orifice defines an inlet;
a main valve and a lower valve operatively located between the sprayable material and the inlet, the valves being in fluid communication with one another and adapted to open and close communication between the sprayable material and the inlet; and
an insert configured to sit within and extend from the inlet, wherein the insert is adapted to move in various directions within the inlet to clear any clogs forming in the actuator assembly.

9. The aerosol system according to claim 6, wherein the sprayable material comprises a propellant.

10. The aerosol system according to claim 6, wherein a user clears the clogs by moving the insert in a forwards and backwards or side-to-side motion.

11. The aerosol system according to claim 1, wherein the insert extends out from the actuator body by a length of up to about ½ inch.

12. The aerosol system according to claim 1, wherein the insert extends out from the actuator body by a length of from about ⅛ inch to about ½ inch.

13. The aerosol system according to claim 6, wherein the insert is formed from a material selected from the group consisting of silicone, rubber, soft plastic and mixtures thereof.

14. The aerosol system according to claim 6, wherein the insert further includes a flange on one end to direct the sprayable material.

15. An aerosol system comprising a container, a sprayable material and an actuator assembly that sprays the sprayable material from the container, wherein the actuator assembly comprises:
an actuator body;
an orifice formed in the actuator body, wherein the orifice defines an inlet;
a main valve and a lower valve operatively located between the sprayable material and the inlet, the valves being in fluid communication with one another and adapted to open and close communication between the sprayable material and the inlet; and
an insert configured to sit within and extend from the inlet, wherein the insert is formed from a material selected from the group consisting of silicone, rubber, soft plastic and mixtures thereof, the insert being adapted to move in various directions within the inlet to clear any clogs forming in the actuator assembly.

16. The aerosol system according to claim 11, wherein the actuator assembly further includes a button tip disposed on the actuator body.

17. The aerosol system according to claim 1, wherein the insert extends out from the actuator body by a length of up to about ½ inch.

18. The aerosol system according to claim 1, wherein the insert extends out from the actuator body by a length of from about ⅛ inch to about ½ inch.

19. The aerosol system according to claim 11, wherein a user clears the clogs by moving the insert in a forwards and backwards or side-to-side motion.

20. The aerosol system according to claim 11, wherein the insert further includes a flange on one end to direct the sprayable material.
